(19) United States
(12) Patent Application Publication
(10) Pub. No.: US 2022/0351601 A1
(43) Pub. Date: Nov. 3, 2022

(54) SYSTEM AND METHOD FOR PROTECTING INDIVIDUALS WITHIN AN INTERIOR SPACE OF A VEHICLE

(71) Applicants: Dylan Bracey, River Ridge, LA (US); Brett Steele, River Ridge, LA (US)

(72) Inventors: Dylan Bracey, River Ridge, LA (US); Brett Steele, River Ridge, LA (US)

(21) Appl. No.: 17/731,453

(22) Filed: Apr. 28, 2022

Related U.S. Application Data
(60) Provisional application No. 63/182,331, filed on Apr. 30, 2021.

(51) Int. Cl. G08B 21/22; G08B 21/24; G08B 21/02; G06V 20/59; G06V 10/62

(52) U.S. Cl. CPC G08B 21/22; G08B 21/24; G08B 21/0208; G08B 21/0236; G06V 20/593; G06V 10/62

(57) ABSTRACT

A system and methods for monitoring the interior of a vehicle for individuals and environmental hazards to prevent situations that could result in serious harm or loss of life is provided. The system generally comprises a vehicle having an interior space, processor operably connected to at least one sensor, power supply, and non-transitory computer-readable medium coupled to the processor and having instructions stored thereon. The system collects environmental data within the interior of a vehicle to determine conditions within said vehicle. When the conditions are determined to be hazardous based on environmental thresholds of the system, the system will determine whether an individual is currently exposed to the hazardous conditions within the vehicle. An alert may be sent by the system to a user's computing device should it detect an individual within the interior of the vehicle exposed to hazardous conditions.

### CROSS REFERENCES

This application claims the benefit of U.S. Provisional Application No. 63/182,331, filed on Apr. 30, 2021, which application is incorporated herein by reference.

### FIELD OF THE DISCLOSURE

The subject matter of the present disclosure refers generally to a system and method for detecting individuals located within the interior of a vehicle.

### BACKGROUND

Every year children are seriously injured due to circumstances that could have been avoided had people been more observant or technology been more observant for them. These deaths are often not only devastating for families but also the communities in which these families live. One set of circumstances that result in multiple child deaths every year that are certainly avoidable are those circumstances in which a child is left in a vehicle where the environmental conditions within said vehicle are potentially hazardous to the child's health. These situations are particularly devastating to families and communities because they often invoke discussions as to whether criminal charges should be brought against the parent for endangering the child. And though many hold the belief that it is absurd to think they could be so irresponsible to somehow forget about a child within a vehicle, it still happens to people who otherwise might be called competent and responsible. And it can be easy to see why when you realize that many parents are simply not getting enough sleep to function at one hundred percent their normal level in today's high stress environment.

Though there is certainly a demand for a system that could help prevent these types of tragedies, problems with detection methods have prevented them from becoming mainstream. In particular, issues with detection systems determining incorrectly that a child is the back seat of a vehicle have prevented producers of vehicles from offering them as an option to consumers. A system that constantly falsely alerts an owner that their child is still in the back seat and is exposed to extreme heat building within the vehicle would quickly fall out of favor with the public. Further, until recently, the cost of installing such systems in vehicles would have placed said vehicles out of reach of the average consumer. Because the cost of computing devices and sensors has come down significantly over the last decade, it finally may be cost effective to install these systems in vehicles marketed to the average consumer.

Accordingly, there is a need in the art for a system and method for monitoring interior spaces of vehicles for individuals and environmental conditions so that said individuals will not be left in said interior spaces when said environmental conditions may be hazardous to said individual's health.

### SUMMARY

A system and method for monitoring the interior of a vehicle for individuals so that they might not be left in a situation that could result in serious harm or loss of life is provided. In one aspect, the system detects individuals within an interior space of a vehicle and performs a query to determine whether the environmental conditions in said interior space might be hazardous to said individual. In another aspect, the system warns a user when an individual is detected in an interior space of a vehicle while environmental conditions within said interior space could potentially be hazardous to said individual's health. Generally, the system protects individual(s) within interior spaces of vehicles by making sure environmental conditions within said interior spaces are within a safe range for said individual(s) and subsequently alerting users of the system when conditions could and/or have placed said individual(s) in medical distress.

The system generally comprises a vehicle having an interior space, processor operably connected to at least one sensor, power supply, and non-transitory computer-readable medium coupled to the processor and having instructions stored thereon. In some embodiments, the system may comprise a computing entity, wherein said computing entity may comprise a user interface that may allow a user to view data of the system and/or cause the system to perform an action via commands input by said user. The system preferably transmits the various data of the system to a user interface of a user's computing entity so that it may be presented to said user in a way that encourages said user to act in the best interest of the individual. In particular, the system is designed to alert users when an individual within a vehicle is in danger due to a hazardous environmental condition within said vehicle.

The system may comprise environmental threshold limits, which may represent the maximum/minimum value a particular category of condition data may reach before triggering a warning within the system. Environmental threshold limits may be automatically set by the system or input by a user via the user interface. A camera and/or at least one sensor may be secured within the vehicle in a way such that it may measure conditions within said vehicle and transmit image data and/or environmental data to the processor and/or computing entity, which the processor may to perform the various functions of the system. In a preferred embodiment, the camera and/or at least one sensor is located at an elevated position in the front region of the interior space of a vehicle so that it may monitor the entire interior space of a vehicle. Other preferred embodiments of the system may comprise sensor assistance devices configured to assist the at least one sensor monitor areas of a vehicle's interior space that said at least one sensor may be unable to monitor due to the position of the at least one sensor.

Further, the system may use image data and environmental data associated with a plurality of temporal points to create detailed charts that may be presented to the user within the user interface, allowing a user to view detailed plots that outline not only the environmental conditions within a vehicle over a period of time. Data associated with a plurality of temporal points might also be used with security systems of the vehicle to determine geographic areas that experience higher rates of medical emergencies due to adverse environmental conditions within vehicles and/or areas that experience higher rates of vehicle related property crime in addition to assisting emergency medical personnel and law enforcement to help protect individuals within interior spaces of a vehicle.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is a diagram of an example environment in which techniques described herein may be implemented.

FIG. 3 is a diagram of an example environment in which techniques described herein may be implemented.

FIG. 4 is a diagram illustrating a system embodying features consistent with the principles of the present disclosure.

FIG. 5 is a diagram illustrating a user interface embodying features consistent with the principles of the present disclosure.

FIG. 6 is a diagram illustrating the manner in which individual access to data may be granted or limited based on permission levels.

FIG. 7 is a diagram illustrating a system embodying features consistent with the principles of the present disclosure.

FIG. 8 a diagram illustrating a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Although the description generally refers to protecting individuals within rear seating areas of a vehicle, one with skill in the art will understand that the system may be used to protect individuals within other areas of a vehicle without departing from the inventive subject matter described herein.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. The term “object database” and grammatical equivalents thereof are used herein to mean a NoSQL database. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). The term “homeotherm” and grammatical equivalents thereof are used herein to mean an organism that maintains its body temperature at a constant level, usually above that of the environment, by its metabolic activity. In particular, homeotherm refers to all mammals and birds (and some reptiles) that can benefit from the disclosed methods, but are not limited to, humans; domesticated animals such as dogs and cats; livestock such as horses, cattle, pigs, sheep, goats, and chickens; and other animals such as mice, rats, guinea pigs, and hamsters.

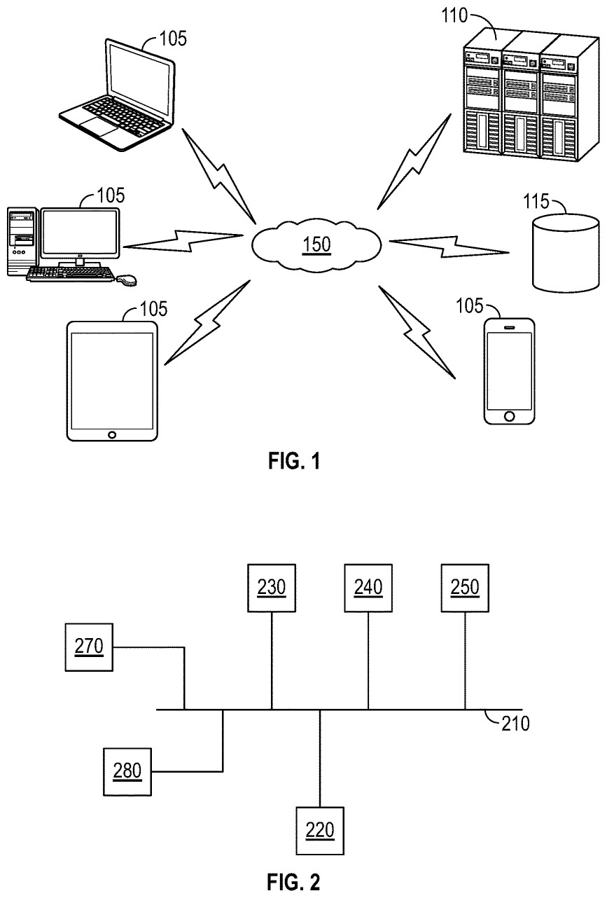

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for example, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for example, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 410, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device 408 and/or an output device 910. As used herein, an input device 408 may be defined as a device that allows a user 405 to input data and instructions that is then converted into a pattern of electrical signals in binary code that are comprehensible to a computing entity 200. An input device 408 of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device 910 may be defined as a device that translates the electronic signals received from a computing entity 200 into a form intelligible to the user 405. An output device 910 of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

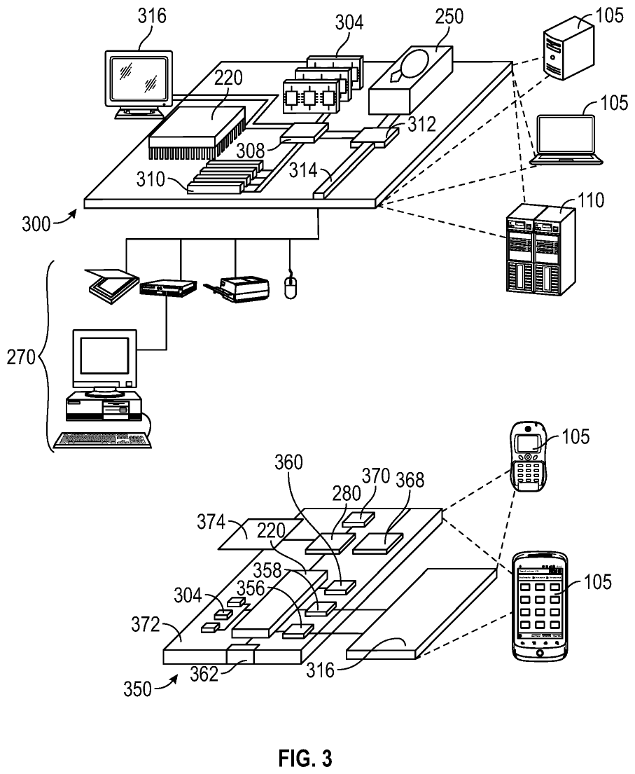

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device 910, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For example, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 410, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation- and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when it is not connected to a stationary power outlet or if the stationary power outlet ceases to provide power to the computing entity 200.

The power supply may be any source of power that provides the system 400 with electricity. In one preferred embodiment, the system 400 may comprise of multiple power supplies that may provide power to the system 400 in different circumstances. For instance, the system 400 may be connected to a vehicle's 705 battery system, which may provide power to the system 400 so long as the battery is charge or so long as the vehicle 705 is plugged into a stationary power source. In a preferred embodiment, the stationary power source may be a charging station for an electric vehicle 705. However, the system 400 may also be connected to a battery backup so that the system 400 does not drain a vehicle's 705 primary battery or so that it may receive power even when not receiving power from a stationary power outlet. In another preferred embodiment, a plurality of solar charging panels may be operably connected to system 400 in a way that provides power thereto. Said plurality of solar panels may be configured to provide power to the system 400 in conjunction with a battery when not connected to a stationary power source. Using a mixture of the embodiments of a power supply described herein may allow the system 400 to always receive power so that it may continuously monitor vehicles 705 for individuals 715 and hazardous environmental conditions as well as alert users 405 when individuals 715 are experiencing hazardous environmental conditions in said vehicles 705.

In some preferred embodiments, the battery may be operably connected to the processor 220 in a way such that the processor 220 may regulate the amount of power the battery provides to the system 400. For instance, a system 400 comprising an accelerometer may cause the processor 220 to limit the amount of power the system 400 is receiving when it is determined via the acceleration data received by said accelerometer that the vehicle 705 is in motion. For instance, an accelerometer may be used by the system 400 for motion tracking and the more power intensive GPS may be used for exact geolocation. Therefore, the processor 220 may be used to limit the power transferred from the battery to the GPS unit except in instances where the system 400 has determined that exact geolocation is desirable.

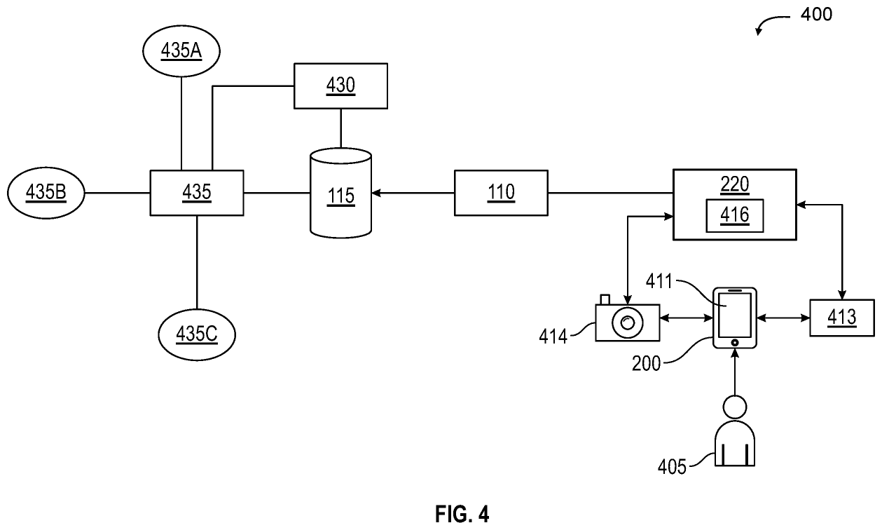

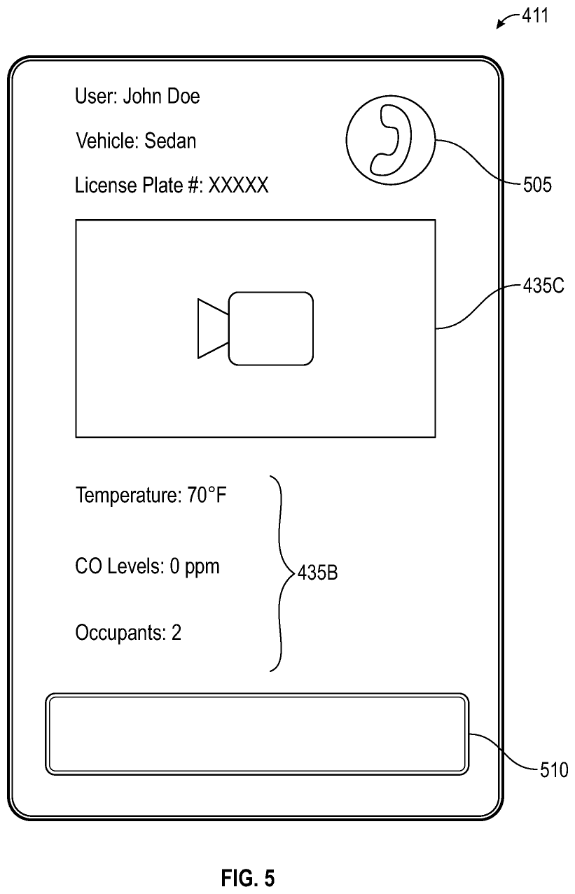

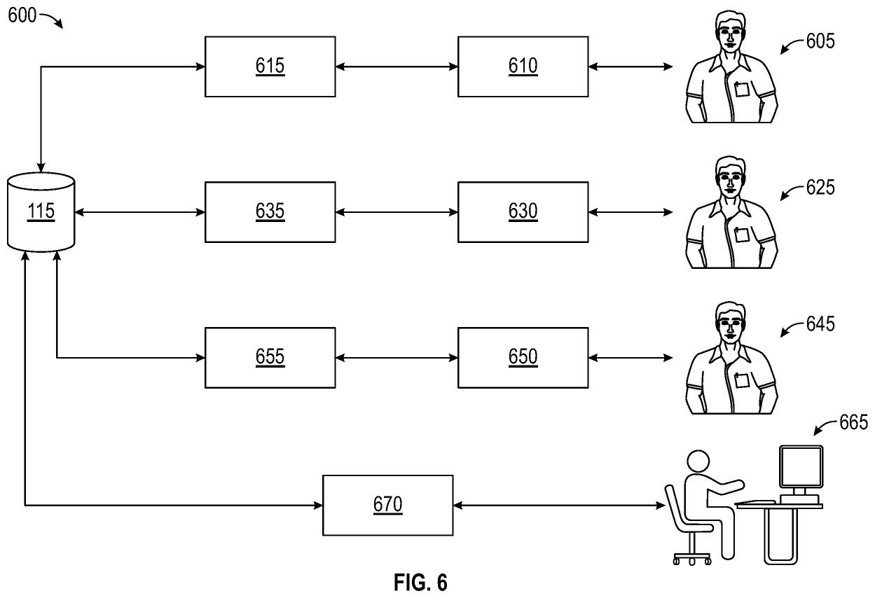

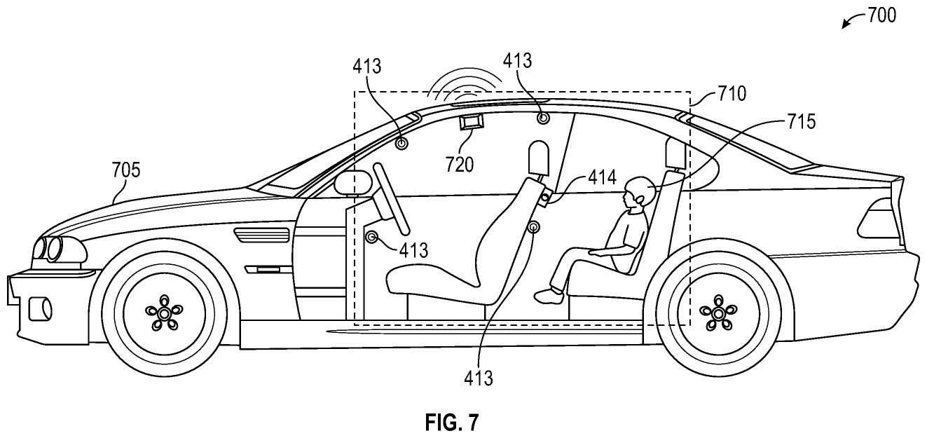

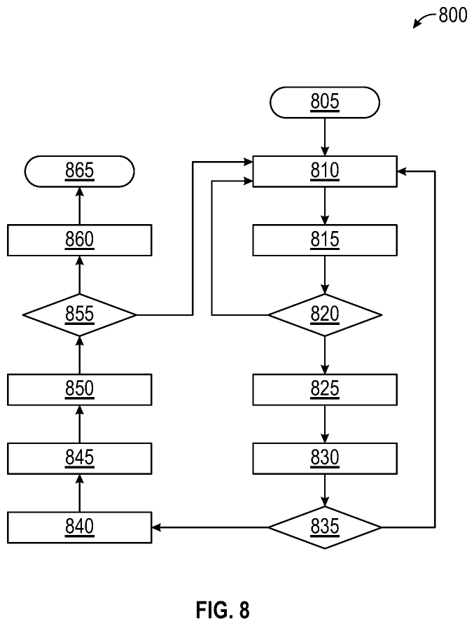

FIGS. 4-8 illustrate embodiments of a system 400 for detecting homeotherms 715 seated within a vehicle 705 in order to prevent a situation that could result in serious harm or loss of life. In particular, the system illustrated in FIGS. 4-8 is designed to detect individuals within interior spaces 710 of a vehicle while monitoring environmental conditions within said vehicle. FIG. 4 depicts a preferred embodiment of a system 400 designed to monitor and protect homeotherms 715 within the interior of a vehicle 705. FIG. 5 illustrates an embodiment of a user interface 411 of the system 400. FIG. 6 illustrates permission levels 600 that may be utilized by the present system 400 for controlling access to content 615, 635, 655 of the system 400. FIG. 7 illustrates the system 400 that is installed within a vehicle 705 and operating within an environment 700. FIG. 8 illustrates a method that may be carried out by the system 400. It is understood that the various method steps associated with the methods of the present disclosure may be carried out as operations by the system 400 depicted in FIG. 4.

As illustrated in FIG. 4, the system 400 generally comprises a vehicle 705 having an interior space 710, processor 220 operably connected to at least one sensor 413, power supply, and non-transitory computer-readable medium 416 coupled to the processor 220 and having instructions stored thereon. In one embodiment, the system 400 may comprise a computing entity 200, wherein said computing entity 200 may comprise a user interface 411 that may allow a user 405 to view data of the system 400 and/or cause the system 400 to perform an action via commands input by said user 405. In another embodiment, the system 400 may comprise a database 115 operably connected to the processor 220, which may be used to store the various data of the system 400 therein. In yet another preferred embodiment, a server 110 may be operably connected to the processor 220 and/or database 115, facilitating the transfer of information between the processor 220 and database 115. The system 400 preferably transmits the various data of the system 400 to a user interface 411 of a user's 405 computing entity 200 so that it may be presented to said user 405 in a way that encourages said user 405 to act. In particular, the system 400 is designed to alert users 405 when a homeotherm 715 within a vehicle 705 is in danger due to a hazardous environmental condition within said vehicle 705. For instance, a warning presented to a parent via a notification of the parent's cell phone may encourage the parent to act in a way that assists a child strapped in a car seat of said parent's car who may be in danger due to hazardous conditions within said car.

In a preferred embodiment, the programming instructions responsible for the operations carried out by the processor 220 are stored on a non-transitory computer-readable medium 416 (“CRM”), which may be coupled to the server 110, as illustrated in FIG. 4. Alternatively, the programming instructions may be stored or included within the processor 220. Examples of non-transitory computer-readable mediums 416 include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium 416.

Data within the system 400 may be stored in various profiles. In a preferred embodiment, the system 400 comprises user data 435A and environmental data 435B that may be stored in user profiles 435. A user profile 435 may be defined as a profile containing data about a particular user 405. User data 435A may be defined as data that may be used to identify a particular user 405 of the system 400. User data 435A may include, but is not limited to, name, date of birth, address, driver's license number, geolocation, car make, car model, vehicle identification number, license plate number, or any combination thereof. Environmental data 435B may be defined as data concerning the physical environment within the interior space 710 of a vehicle 705. Environmental data 435B may include, but is not limited to, geolocation data, temperature, humidity level, parts per million of a particular gas, sound, vibrations, sudden movements, or any combination thereof. User data 435A and environmental data 435B allows users 405 to control when the system 400 may alert users 405 of instances when homeotherms 715 are located in interior spaces 710 having hazardous environmental conditions.

In one preferred embodiment, the system 400 may comprise environmental threshold limits 430, wherein said environmental threshold limits 430 may be defined as the maximum/minimum value a particular category of condition data may reach before triggering a warning within the system 400. In a preferred embodiment, environmental thresholds are stored within user profiles 435. Environmental threshold limits 430 may be automatically set by the system 400 or input by a user 405 via the user interface 411. For instance, the system 400 may be configured to automatically set a environmental threshold limit 430 for temperature at a maximum value of 80° F. and a minimum value of 50° F. If the system 400 determines that the temperature within the interior space 710 is higher than 80° F. or lower than 50° F. while a homeotherm 715 is detected in said interior space 710, the system 400 may alert the user 405 that the conditions within the interior space 710 may be hazardous to said homeotherm's 715 health. For instance, a user 405 may set a environmental threshold limit 430 for temperature to a minimum value of 32° F. via a user interface 411 of a computing because they keep a pet in the rear seating area who may have a higher tolerance for lower temperatures. If the system 400 determines that the temperature within the interior space 710 is lower than 32° F., the system 400 may alert the user 405 that the conditions within the interior space 710 may have become hazardous to their pet's health.

As illustrated in FIG. 4, the system 400 may comprise a database 115 operably connected to the processor 220. The database 115 may be operably connected to the processor 220 via wired or wireless connection. In a preferred embodiment, the database 115 is configured to store user data 435A and environmental data 435B therein. Alternatively, the user data 435A and environmental data 435B may be stored on the non-transitory computer-readable medium 416. The database 115 may be a relational database such that the user data 435A and environmental data 435B associated with each user profile 435 within the plurality of user profiles 435 may be stored, at least in part, in one or more tables. Alternatively, the database 115 may be an object database such that user data 435A and environmental data 435B associated with each user profile 435 within the plurality of user profiles 435 may be stored, at least in part, as objects. In some instances, the database 115 may comprise a relational and/or object database and a server 110 dedicated solely to managing the user data 435A and environmental data 435B in the manners disclosed herein.

As mentioned previously, one embodiment of the system 400 may further comprise a computing entity 200 operably connected to the processor 220. A computing entity 200 may be implemented in a number of different forms, including, but not limited to, servers 110, multipurpose computers, mobile computers, etc. For instance, a computing entity 200 may be implemented in a multipurpose computer that acts as a personal computer for a user 405, such as a laptop computer. For instance, components from a computing entity 200 may be combined in a way such that a mobile computing entity 200 is created, such as mobile phone. Additionally, a computing entity 200 may be made up of a single computer or multiple computers working together over a network. For instance, a computing entity 200 may be implemented as a single server or as a group of servers working together over and Local Area Network (LAN), such as a rack server system 400. Computing entities 200 may communicate via a wired or wireless connection. For instance, wireless communication may occur using a Bluetooth, Wi-Fi, or other such wireless communication device 720.

The computing entity 200 may further comprise a display 316. A display 316 may be defined as an output device that communicates data that may include, but is not limited to, visual, auditory, cutaneous, kinesthetic, olfactory, and gustatory, or any combination thereof. Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of a visual representation of environmental data 435B via a liquid crystal display (LCD), wherein the hard copy of the visual representation of environmental data 435B may be stored on a local hard drive. For instance, a display 316 may present a soft copy of audio information via a speaker, wherein the hard copy of the audio information is stored on a flash drive. For instance, a display 316 may present a soft copy of user data 435A, wherein the hard copy of the user data 435A is stored within a database 115. Displays 316 may include, but are not limited to, cathode ray tube monitors, LCD monitors, light emitting diode (LED) monitors, gas plasma monitors, screen readers, speech synthesizers, haptic suits, speakers, and scent generating devices, or any combination thereof, but is not limited to these devices.

The at least one sensor 413 may be secured within the vehicle 705 in a way such that it may measure conditions within said vehicle 705. In a preferred embodiment, the at least one sensor 413 is located at an elevated position in the front region of the interior space 710 of a vehicle 705 so that it may monitor the entire interior space 710 of a vehicle 705. For instance, the at least one sensor 413 may be located above the rear-view mirror or hanging form a vizor of a car so that it may monitor the front seating area and rear seating area of said car. In other preferred embodiments, the at least one sensor 413 may be located within the interior space 710 in a way such that it only monitors a particular region of said vehicle 705. For instance, a first at least one sensor 413 may be secured to a center console to monitor the front seating area of a vehicle 705 and a second at least one sensor 413 may be secured to the back of a front seat to monitor the rear seating area of said vehicle 705. In yet another preferred embodiment, the system 400 may comprise an at least one sensor 413 configured to monitor the entire interior space 710 of a vehicle 705 and another at least one sensor 413 configured to monitor a particular region of said vehicle 705. For instance, a first at least one sensor 413 may be affixed to the dashboard of an emergency personnel vehicle 705 so that it detects individuals and environmental conditions within the entire interior space 710 of said vehicle 705 while a second at least one sensor 413 secured within a rear seating area of said vehicle 705 is configured to monitor only the rear seating area for individuals and environmental conditions. Other preferred embodiments of the system 400 may comprise sensor assistance devices configured to assist the at least one sensor 413 monitor areas of a vehicle's 705 interior space 710 that said at least one sensor 413 may be unable to monitor due to the position of the at least one sensor 413. For instance, a vehicle 705 having at least one sensor 413 located in the front seating area may further comprise at least one infrared reflective mirror positioned in a way that allows said at least one sensor 413 to monitor regions within a rear seating area that said at least one sensor 413 may otherwise be unable to monitor due to structures obstructing said at least one sensor's 413 line of sight.

In one preferred embodiment, the at least one sensor is configured to transmit environmental data 435B to the processor 220. Alternatively, the system 400 may receive data from an at least one sensor 413 operably connected to the computing entity 200, wherein the processor 220 may be operably connected to the computing entity 200 in a way such that information may be transmitted to said processor 220 from said computing entity 200. The processor 220 may then use this information to perform the various functions of the system 400. For instance, a computing entity 200 connected to the at least one sensor 413 may allow the processor 220 to receive environmental data 435B collected from said at least one sensor 413, process said data, and assign indicia to within a user interface 411 of the computing entity 200, wherein said indicia may alert the user 405 or a third-party user 405 that a homeotherm 715 seated with an interior space 710 of a vehicle 705 is experiencing hazardous environmental conditions. Types of conditions that may be measured by the system 400 include, but are not limited to, temperature, humidity level, parts per million of a particular gas, sound, vibrations, sudden movements, or any combination thereof. Types of sensors that may be used as an at least one sensor 413 include, but are not limited to, a thermometer, hygrometer, gas detector, microphone, vibration sensor, ultrasonic sensor, infrared sensor, microwave sensor, photoelectric sensor, time-of-flight sensor, accelerometer, gyroscope, or any combination thereof.

Some preferred embodiments of the system 400 may comprise a geolocation device which may be used to collect geospatial data related to a vehicle's 705 geolocation. The geolocation device may be a single component of a larger computing device, such as the Global Positioning System (GPS) receiver module. In a preferred embodiment, the geolocation device is part of a mobile computing device. In one preferred embodiment, the geolocation device may comprise a plurality of devices working together to obtain a geolocation via triangulation. In a preferred embodiment, the geolocation device is a GPS sensor. The GPS sensor may measure and transmit geospatial data relevant for determining geolocation. A GPS sensor may be defined as a receiver having an antenna designed to communicate with a navigation satellite system. Geospatial data may be spatial data including, but not limited to, numeric data, vector data, and raster data, or any combination thereof. Numeric data may be statistical data which includes a geographical component or field that can be joined with vector files so the data may be queried and displayed as a layer on a map in a GIS. Vector data may be data that has a spatial component, or X, Y coordinates assigned to it. Vector data may contain sets of points, lines, or polygons that are referenced in a geographic space. Raster data may be data in a JPG, .TIF, .GIF or other picture file format. For instance, a map scanned in a flatbed scanner may be considered raster data. A raster dataset may comprise a number of cells, wherein every cell within the plurality of cells of the raster dataset belongs to at least one zone. Each group of connected cells in a zone is considered a region. A zone that consists of a single group of connected cells may have only one region, and the number of cells that make up a region has no practical limit. Zones may be composed of as many regions as necessary to represent a map feature, which may be used by a user 405 to help locate their vehicle 705.

In yet another preferred embodiment, the system 400 may further comprise a camera 414 configured to relay image data 435C to the processor 220, which may be in the form of pictures or video. In one preferred embodiment, the camera 414 may be configured to constantly capture image data 435C and relay said image data 435C to the processor 220. In another preferred embodiment, the camera 414 may be configured to only capture image data 435C when the system 400 detects a homeotherm 715 within the interior space 710 of a vehicle 705. In yet another preferred embodiment, the system 400 may be configured to only capture image data 435C when a homeotherm 715 and hazardous environmental condition are detected in the interior space 710. This image data 435C may be used by the system 400 to confirm the presence of a homeotherm 715 within the interior space 710. Alternatively, image data 435C may be sent to a computing entity 200 of a user 405 along with an alert so that a user 405 may view the interior space 710 to confirm that there is a homeotherm 715 in the interior space 710 as well as to make sure that any homeotherms 715 within that interior space 710 are safe. The system 400 may also send the image to a third-party user 405, such as a fire department, so that the third-party user 405 could confirm that there is an emergency prior to dispatching emergency personnel.

Some embodiments of the system 400 may use temporal points to determine if a homeotherm 715 is at risk due to unfavorable environmental conditions within the vehicle 705. The environmental data 435B and/or image data 435C collected by the system 400 may have a plurality of temporal points associated therewith, which may be used by the system 400 to produce a timeline that may be used to illustrate the environmental conditions within the vehicle 705 as well as when a homeotherm 715 was located within the vehicle 705 over a period of time. For instance, a first temporal point and a second temporal point may be used determine a temporal range, wherein a plurality of temporal points located between said first temporal point and said second temporal point also make up said temporal range. The system 400 may then analyze environmental data 435B and image data 445C within said temporal range to determine not only the environmental conditions within a vehicle 705 during said temporal range but also if homeotherms 715 were located within the vehicle 705 during this temporal range. There may be instances in which a homeotherm 715 was located within a vehicle 705 experiencing adverse environmental conditions in multiple short bursts, which may cause the system 400 to determine that said homeotherm 715 is at less of a risk of experiencing conditions hazardous to said homeotherm's health that a homeotherm 715 who experienced said hazardous conditions without interruption.

Further, the system 400 may use environmental data 435B and image data 435C associated with a plurality of temporal points to create detailed charts that may be presented to the user within the user interface 411, allowing a user 405 to view detailed plots that outline not only the environmental conditions within a vehicle 705 over a period of time, such as during a day, week, month, but also when the vehicle 705 is being used most by the user 405 to perform tasks such as transporting homeotherms 715. This data might be used with geolocation data to help recommend locations in which a user 405 should park their vehicle 705 to reduce the likelihood of the vehicle 705 experiencing adverse environmental conditions within its interior. This data might also be used with security systems of the vehicle 705 to determine geographic areas that experience higher rates of medical emergencies due to adverse environmental conditions within vehicles 705 and/or areas that experience higher rates of vehicle related property crime. For instance, the system 400 might use this information to alert a user 405 that the zip code in which they are currently located has a higher than average number of children who die and/or experience medical distress due to adverse environmental conditions within a vehicle 705 than what is experienced in other parts of the country. This data may also be used to assist emergency medical personnel and law enforcement. For instance, the system 400 may alert emergency medical personnel to be on high alert in a particular area on a particular day due to weather that may cause adverse conditions within a vehicle 705 at a higher rate than normal. For instance, the system 400 may alert law enforcement of a series of motor vehicle thefts in a particular area and provide image data 430C pertaining to said motor vehicle thefts in order to assist law enforcement so that they may more easily apprehend the perpetrator of said motor vehicle thefts. As more vehicles are equipped with the system 400 described herein, more data may be collected, which may increase the accuracy of the assistance provided to the user 405, emergency medical personnel, and law enforcement.

In one preferred embodiment, image data 435C may be stored in databases 115 for later use. For instance, police may later examine image data 435C of the system 400 to track a suspect during commission of a crime or to track a suspect after the crime has been committed. This could be particularly useful for determining culpability in cases where a child was left in the interior space 710 of a vehicle 705 while the conditions in that interior space were hazardous and resulted in harm to said child. In another preferred embodiment, machine learning techniques may be used to analyze the image data 435C. For instance, image data 435C may be sent to a server 110 where machine learning techniques would be used to analyze the image data 435C before sending the analysis of said image data 435C to the processor 220.

As mentioned previously, some preferred embodiments of the system 400 may further comprise a user interface 411. A user interface 411 may be defined as a space where interactions between a user 405 and the system 400 may take place. In a preferred embodiment, the interactions may take place in a way such that a user 405 may control the operations of the system 400, and more specifically, allow a user 405 to monitor the environmental conditions within a vehicle. A user 405 may input instructions to control operations of the system 400 manually using an input device. For instance, a user 405 may choose to alter environmental threshold limits of the system 400 by using an input device of the system 400, including, but not limited to, a keyboard, mouse, or touchscreen. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 400 may present data of the user interface 411 to the user via a display 316 operably connected to the processor 220.

In another preferred embodiment, the user interface 411 may comprise an emergency button 505 that may allow the user 405 to alert third-party users 405 of an emergency situation, including the exact geolocation of the emergency. Other preferred embodiments of the system 400 may comprise a physical switch located in the vehicle 705 that may be activated to cause the system to alert third-party users 405 of an emergency situation. For instance, an emergency operator may be alerted of an accident via the emergency button or 505 emergency switch and then use image data 435C of the system 400 to dispatch the appropriate emergency personnel to the vehicle's 705 geolocation. In another preferred embodiment, the user interface 411 may comprise a delay button 510 that may cause the system 400 to delay for a specified period of time before detecting hazardous conditions and/or homeotherms 715. In a preferred embodiment, the system 400 may be delayed five minutes before detecting hazardous conditions and homeotherms 715. For instance, a user 405 placing children in car seats within the rear seating area of a vehicle 705 in the middle of the summer may want to delay the system 400 long enough for the car to cool down. If the user 405 was unable to delay the system 400, the user 405 may receive an alert despite the children not being in danger.

In a preferred embodiment, users 405 may access data of the system 400 via the user interface 411, which may be accomplished by causing the processor 220 to query the non-transitory computer-readable medium 416 and/or database 115. The non-transitory computer-readable medium 416 and/or database 115 may then transmit data back to the processor 220, wherein the processor 220 may present it to the user 405 via a display 316. This information may be presented to the user 405 in a way such that the user 405 may set preferred environmental conditions within a vehicle 705. The user interface 411 may also allow the user 405 to input data about particular homeotherms 715 who may be sitting within the interior space 710, which may assist the system 400 detect said particular homeotherms 715 in interior spaces 710. In one preferred embodiment, the user interface 411 of the system 400 may allow a user 405 to direct how the system 400 will alert a user 405. For instance, the system 400 may be configured to alert a user 405 after a certain amount of time has passed after detection of the homeotherm 715 in the front seating area as well as the hazardous environmental conditions. For instance, the system 400 may be configured to alert a third-party user 405, such as a police department, after an individual has spent a certain amount of time within a rear seating area having a hazardous environment and after the user 405 has been alerted. Therefore, some preferred embodiments of the system 400 may be used to alert multiple users 405 to ensure the safety of homeotherms 715 in interior spaces 710.

To prevent un-authorized users 405 from accessing data within the user profiles 435 of the system 400, the system 400 may employ a security method. As illustrated in FIG. 6, the security method of the system 400 may comprise a plurality of permission levels 600 that may allow a user 405 to view content 615, 635, 655 within the database 115 while simultaneously denying users 405 without appropriate permission levels 600 the ability to view said content 615, 635, 655. To access the data stored within the database 115, users 405 may be required to make a request via a user interface 411. Access to the data within the database 115 may be granted or denied by the processor 220 based on verification of a requesting user's 605, 625, 645 permission level. If the requesting user's 605, 625, 645 permission level 600 is sufficient, the processor 220 may provide the requesting user 605, 625, 645 access to content 615, 635, 655 stored within the system 400. Conversely, if the requesting user's 605, 625, 645 permission level 600 is insufficient, the processor 220 may deny the requesting user 605, 625, 645 access to content 615, 635, 655 stored within the system 400. In an embodiment, permission levels 600 may be based on user roles 610, 630, 650 and administrator roles 670, as illustrated in FIG. 6. User roles 610, 630, 650 allow users to access content 615, 635, 655 that a user has uploaded and/or otherwise obtained through use of the system 400. Administrator roles 670 allow administrators 665 to access system 400 wide data, including managerial permissions, as well as assign new tasks to other users.

In an embodiment, user roles 610, 630, 650 may be assigned to a user in a way such that a requesting user 605, 625, 645 may access user profiles 435 via a user interface 411. To access the data within the database 115, a user may make a user request via the user interface 411 to the processor 220. In an embodiment, the processor 220 may grant or deny the request based on the permission level 600 associated with the requesting user 605, 625, 645 assigned via user roles 610, 630, 650. Only users 405 having appropriate user roles 610, 630, 650 or administrator roles 670 may access the content 615, 635, 655. For instance, as illustrated in FIG. 6, requesting user 1 605 has a permission level 600 to view user 1 content 615 whereas requesting user 2 625 has a permission level 600 to view user 1 content 615, user 2 content 635, and user 3 content 655. Alternatively, content 615, 635, 655 may be restricted in a way such that a user 405 may only view a limited amount of content 615, 635, 655. For instance, requesting user 3 645 may be granted a permission level 600 that only allows them to view user 3 content 655 related to a particular vehicle 705. Therefore, the permission levels 600 of the system 400 may be assigned to users 405 in various ways without departing from the inventive subject matter described herein.

FIG. 8 provides a flow chart 500 illustrating certain, preferred method steps that may be used to carry out the method of alerting users 405 that a homeotherm 715 seated within an interior space 710 of a vehicle 705 are subject to environmental conditions that may be hazardous to said homeotherm's 715 health. Step 805 indicates the beginning of the method. During step 810, the processor 220 receives first environmental data 435B from at least one sensor 413. Once the data has been received, the processor 220 may perform a query to determine if the first environmental data 435B of the at least one sensor 413 is outside an environmental threshold limit 430 during step 815. Based on the results of the query, the processor 220 may perform an action during step 820. If the processor 220 determines that the first environmental data 435B is not outside an environmental threshold limit 430, the system 400 may return to step 810. If the processor 220 determines that the first environmental data 435B is outside an environmental threshold limit 430, the system 400 may collect second environmental data 435B during step 825 and subsequently perform a query to determine if a homeotherm 715 is within the interior space 710 of the vehicle 705 using said second environmental data 435B during step 830.

Based on the results of the query, the processor 220 may take an action during step 835. If the processor 220 determines that no homeotherm 715 is located within the interior space 710, the processor 220 may return to step 810. If the processor 220 determines that a homeotherm 715 is located within the interior space 710, the system 400 may create a semi-passive timer during step 840, wherein said semi-passive timer determines when the system 400 may attempt to detect a homeotherm 715 within the interior space 710 of a vehicle 705 a second time. In a preferred embodiment, the amount of time the system 400 allots for the semi-passive time may be based on the severity of the environmental condition within the interior space 710, wherein the severity of said environmental condition is based on said first environmental data 435B that the system 400 has continued to collect. For instance, the time allotted amount to a semi-passive timer may be larger when the temperature within a vehicle 705 is determined to be slightly lower than the minimum environmental threshold limit 430 than when the system 400 determines that the amount of carbon monoxide within a vehicle 705 is higher than the maximum environmental threshold limit 430 In another preferred embodiment, the semi-passive timer may be configured in a way such that the processor 220 will cause said semi-passive timer to decrease at a faster rate if the system 400 determines that the environmental conditions within the interior space 710 of the vehicle 705 are worsening. For instance, if the semi-passive timer was triggered due to a temperature that was higher than the highest environmental threshold limit 430 for temperature, the processor 220 may cause the semi-passive timer to increase the rate at which it counts down if the system 400 determines that the temperature within said vehicle 705 is continuing to rise.

Once the semi-passive timer has finished counting down, the processor 220 may receive said second environmental data 435B a second time during step 845. The processor 220 may then perform a query to confirm that a homeotherm 715 is within the interior space 710 of the vehicle 705 during step 850. Based on the results of the query, the processor 220 may perform an action during step 855. If the processor 220 does not confirm that a user 405 is located within the interior space 710 of a vehicle 705, the processor 220 may return to step 810. If the processor 220 confirms that a homeotherm 715 is located within the interior space 710, the processor 220 may transmit an alert signal to a computing entity 200 of a user 405 during step 860. In a preferred embodiment, the alert signal contains user data 435A, environmental data 435B, and image data 435C. Once the processor 220 has transmitted the alert signal, the system 400 may proceed to the terminate method step 865.

Though many different types of environmental data 435B may be used to detect a homeotherm 715 within an interior space 710 of a vehicle 705, in a preferred embodiment, an infrared camera 414 is used to capture grayscale image data 435C of the interior of the vehicle 705. The processor 220 may then pass the grayscale image data 435C through a gamma correction filter and a contrast filter to black-out background heat and create a greater disparity between the heat emitted by a living organism and the ambient heat of the vehicle 705. The settings used for the various filters that enable the creation of said greater disparity preferably cannot be changed by a user 405. However, some embodiments of the system may allow users 405 and/or administrators of the system 400 to alter said settings. Further, some embodiments may alter the settings of the various filters based on certain environmental data available to the system 400. For instance, the values of a gamma filter may be changed by the processor 220 depending on the luminosity. If the processor 220 detects a heat blob in the gamma-corrected, contrasted, grayscale image data 435C, the system 400 may consider said heat blob a living organism. In a preferred embodiment, the system 400 will only consider a heat blob a living organism if the region within the grayscale image data 435C containing said heat blob is at least 50 pixels and has a grayscale value within a specified range, such as between 15 and 255 pixels. In other preferred embodiments, the heat blob may be required to be within a designated region of interest, wherein said designated region of interest is an area a homeotherm 715 is most likely to be located within the image data 435C and is designated when the system 400 is placed in a vehicle 705.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for monitoring individuals and environmental conditions comprising:
a vehicle having an interior space,
at least one sensor within said vehicle,
wherein said at least one sensor is configured to detect environmental conditions,
wherein said at least one sensor is configured to detect an individual in said interior space,
a processor operably connected to said at least one sensor,
a computing device having a user interface and operably connected to said processor,
wherein said user interface allows a user to view environmental data, and
a non-transitory computer-readable medium coupled to said processor,
wherein said non-transitory computer-readable medium contains instructions stored thereon, which, when executed by said processor, cause said processor to perform operations comprising:
receiving said environmental data from said at least one sensor,
determining whether said environmental data is outside of an environmental threshold limit,
determining whether said individual is located within said interior space based on said environmental data, and
transmitting a computer readable signal when said individual is detected within vehicle while said environmental data is outside said environmental threshold limit.

2. The system of claim 1, wherein said environmental data is saved within said non-transitory computer-readable medium.

3. The system of claim 1, wherein said non-transitory computer-readable medium contains additional instructions, which, when executed by said processor, cause said processor to perform additional operations comprising:
determining that said individual was located within said interior space at a first temporal point,
determining that said individual was located within said interior space at a second temporal point, and
determining that said individual was within said interior space at a plurality of temporal points between said first temporal point and said second temporal point.

4. The system of claim 3, wherein said non-transitory computer-readable medium contains said additional instructions, which, when executed by said processor, cause said processor to perform said additional operations comprising:
determining if said environmental data was outside of said environmental threshold limit during said first temporal point, second temporal point, and said plurality of temporal points.

5. The system of claim 4, wherein said non-transitory computer-readable medium contains said additional instructions, which, when executed by said processor, cause said processor to perform said additional operations comprising:
transmitting an alert signal when said individual was located within said interior space while said environmental data was outside of said environmental threshold limit during said first temporal point, second temporal point, and plurality of temporal points.

6. The system of claim 4, wherein said non-transitory computer-readable medium contains said additional instructions, which, when executed by said processor, cause said processor to perform said additional operations comprising:
transmitting an alert signal when said individual was located within said interior space during said first temporal point, second temporal point, and plurality of temporal points,
wherein said environmental data was outside of said environmental threshold limit during a majority of said first temporal point, second temporal point, and plurality of temporal points.

7. The system of claim 1, further comprising a camera operably connected to said processor,
wherein said camera captures image data used to detect said individual in said interior space.

8. The system of claim 7, further comprising a database operably connected to said processor,
wherein said image data is stored within a database,
wherein said user interface is configured in way that allows said user to view said image data stored within said database.

9. The system of claim 7, wherein said non-transitory computer-readable medium contains additional instructions, which, when executed by said processor, cause said processor to perform additional operations comprising:
receiving image data from said camera, and
analyzing said image data to detect said individual within said interior space.

10. The system of claim 9, wherein said non-transitory computer-readable medium contains additional instructions, which, when executed by said processor, cause said processor to perform additional operations comprising:
analyzing said image data to determine if said individual is under medical distress.

11. The system of claim 10, wherein said non-transitory computer-readable medium contains additional instructions, which, when executed by said processor, cause said processor to perform additional operations comprising:
transmitting an alert signal when it is determined that said individual is medical under distress.

12. A system for monitoring individuals and environmental conditions comprising:
a vehicle having an interior space,
at least one sensor within said vehicle,
wherein said at least one sensor is configured to detect environmental conditions,
a camera configured to collect image data,
wherein said image data is used to detect an individual in said interior space,
a processor operably connected to said at least one sensor and said camera,
a computing device having a user interface and operably connected to said processor,
wherein said user interface allows a user to view said image data, and
a non-transitory computer-readable medium coupled to said processor,
wherein said non-transitory computer-readable medium contains instructions stored thereon, which, when executed by said processor, cause said processor to perform operations comprising:
receiving environmental data from said at least one sensor,
determining whether said environmental data is outside of an environmental threshold limit,
receiving image data from said camera,
analyzing said image data to detect said individual within said interior space, and
transmitting a computer readable signal when said individual is detected within said vehicle while said environmental data is outside said environmental threshold limit.

13. The system of claim 12, wherein said environmental data and said image data is saved within said non-transitory computer-readable medium.

14. The system of claim 13, wherein said user interface is configured in way that allows said user to view said image data.

15. The system of claim 12, wherein said non-transitory computer-readable medium contains additional instructions, which, when executed by said processor, cause said processor to perform additional operations comprising:
analyzing said image data to determine if said individual is under medical distress.

16. The system of claim 13, wherein said non-transitory computer-readable medium contains additional instructions, which, when executed by said processor, cause said processor to perform additional operations comprising:
transmitting an alert signal when it is determined that said individual is medical under distress.

17. A method for monitoring for individuals and environmental conditions comprising steps of:
obtaining an individual detection system comprising at least one sensor and a camera,
wherein said at least one sensor is configured to obtain environmental data,
wherein said camera is configured to obtain image data,
installing said individual detection system within a vehicle having an interior space,
wherein said at least one sensor and said camera are arranged within said vehicle in a way to detect an individual located within said interior space,
configuring said at least one sensor and said camera with a computing device of said individual detection system,
wherein said at least one sensor is configured to send environmental data to a processor operably connected to said at least one sensor,
wherein said camera is configured to send image data to said processor operably connected to said camera,
wherein said processor uses said environmental data and said image data to determine whether an individual is located within said interior space while an environmental condition of said vehicle is hazardous to an individual's health, and
configuring said individual detection system using a user interface of said computing device to transmit a computer readable signal when said individual detection system determines that said individual is located within said interior space while said environmental data is outside of an environmental threshold limit.

18. The method of claim 17, further comprising the step of:
configuring said computing device using said user interface to transmit an alert signal when said individual detection system determines that said individual was located within said interior space during a first temporal point, second temporal point, and plurality of temporal points,
wherein said environmental data was outside of said environmental threshold limit during a majority of said first temporal point, second temporal point, and plurality of temporal points.

19. The method of claim 18, wherein said individual detection system transmits said alert signal to at least one of said computing device and emergency personnel.

20. The method of claim 18, further comprising the step of:
viewing said image data using said user interface when said individual detection system transmits said alert signal.
